(19) United States
(12) Patent Application Publication
(10) Pub. No.: US 2023/0178755 A1
(43) Pub. Date: Jun. 8, 2023

(54) SEALED STATIC BIPOLAR BATTERY AND METHOD OF MAKING AND ASSEMBLING SAME

(71) Applicant: Eos Energy Technology Holdings, LLC, Edison, NJ (US)

(72) Inventors: Francis W. Richey, Edison, NJ (US); Nicholas Szamreta, Edison, NJ (US); Gregory Plichta, Edison, NJ (US); Cyril Fernandez Lourdnathan Joseph, Edison, NJ (US); Vasanthan Mani, Bangalore (IN)

(73) Assignee: Eos Energy Technology Holdings, LLC, Edison, NJ (US)

(21) Appl. No.: 18/074,864

(22) Filed: Dec. 5, 2022

Related U.S. Application Data
(60) Provisional application No. 63/286,379, filed on Dec. 6, 2021.

(51) Int. Cl. H01M 4/66; H01M 50/121; H01M 50/103; H01M 50/562; H01M 50/184; H01M 50/474

(52) U.S. Cl. CPC H01M 4/668; H01M 4/663; H01M 4/661; H01M 50/121; H01M 50/103; H01M 50/562; H01M 50/184; H01M 50/474; H01M 2004/029

(57) ABSTRACT

A static battery with a non-conductive elastomeric or thermoplastic housing. The, battery housing is adapted to receive at least one anode assembly, at least one cathode assembly, and at least one bipolar electrode assembly. At least the bipolar electrode assembly is formed from a conductive plastic resin that is formed as a CPE sheet. A carbon material is affixed to the CPE sheet to form the bipolar electrode. The at least one cathode assembly, the at least one anode assembly and the at least one bipolar electrode assembly are received into the battery box such that a liquid, and/or gas seal is formed, between electrode assemblies. The battery housing has slots into which the electrode assemblies are received. When the electrode assemblies are received into the housing, cells are formed by the cooperation of the electrode assemblies and the battery housing. The cells are then filled with electrolyte such as zinc bromide and a lid is placed on the battery box. Once sealed the battery box is a liquid tight container for the battery.

### CROSS-REFERENCE TO RELATED APPLICATIONS

This application claims the benefit of and priority to U.S. Provisional Application Ser. No. 63/286,379, which was filed on Dec. 6, 2021, and which is incorporated by reference herein.

### TECHNICAL FIELD

The present invention relates to a static, bipolar battery which may have conductive plastic electrodes in addition to a battery box which receives a plurality of electrode assemblies for the bipolar battery. The bipolar battery may be a zinc bromine bipolar battery.

### BACKGROUND

This invention addresses the inherent challenges of sealing and assembling a static bipolar battery containing an electrolyte, and doing so at low cost and high manufacturing throughput. Historically, bipolar battery stacks are assembled by joining separate modular subassemblies of cells or frames together in a manner repeated over the desired number of cells in series for the bipolar stack. Isolation both between adjacent cells and between cells and the environment external to the battery is accomplished using a variety of joining methods, including compression type seals, infrared welding, laser welding, vibration welding, or adhesive type seals. This assembly paradigm limits options for manufacturing and automation, may have poor overall yields due to externally facing seals and may have a number of consecutive subprocesses during assembly of a single stack, that require high levels of process control and tolerancing due to the number of modular parts assembled together, and adds cost to the battery due to the large number of complex modular parts that must be molded or otherwise manufactured. Additionally, all of the above-mentioned joining methods are typically completed using rigid metal electrodes within the frames, where the metal electrodes may provide chemical, thermal, and mechanical resistance to the assembly processes.

Currently, bipolar batteries are formed by joining individual cells together to create the bipolar stack, or building walls around the electrodes to create a sealed box. As noted above, such assembly methods are challenging and expensive. Other proposed designs for conductive plastic electrodes require the frame or battery casing to be co-injection molded with the conductive plastic electrode. However, the challenge with this technique is it severely limits the materials which can be used for the conductive plastic electrode as only a small subset of materials is capable of being injection molded.

Historically, the biggest challenges to the implementation of bipolar batteries are related to sealing of the individual cells, both from the external environment and internally between adjacent cells. In designs where the individual cells are welded together, there is a need for strong welds over large surface areas and in a repeated manner for sealing the battery from the external environment, and on gaskets or seals for sealing adjacent cells internally. These sealing strategies may have high manufacturing variability, long assembly times, and require large amounts of equipment for assembly. Typically, the conductive plastic electrode materials with the best performance must also have a high proportion of conductive diluents relative to the amount of plastic. Such conductive diluents typically contain carbon, graphite, metal, or other conductive materials. When the volume fraction of such diluents is high relative to the lower melting polymer it becomes difficult to weld them together or injection mold them. Therefore, simpler and less expensive constructions and methods of construction for bipolar batteries are sought, which are also more amenable to the materials and methods used to construct such batteries at, lower cost.

### BRIEF SUMMARY

Aspects of the present disclosure provides a sealed battery housing (i.e., a “battery box” herein) which houses the electrodes within and a method for its assembly. The battery box is formed from a non-conductive elastomer or resin. The non-conductive battery box can be formed using conventional techniques such as, for example, injection molding, extrusion, blow molding, rotational molding, etc. The interior of bipolar battery box is configured to accept electrode assemblies in a manner that will provide a liquid seal between battery cells defined by the electrode assemblies and structures such as slots formed in the interior of the battery box, The battery box can be formed In one aspect the battery box contains a plurality of slots extending longitudinally along the length of the battery box. The slots (and the terminal and bipolar electrodes received in them) are housed in the battery box, which has a plurality of longitudinal walls, a plurality of lateral walls, a bottom wall, and a top portion. Each slot is at least partially separated from its neighboring slot(s) by dividers. In one aspect, each divider is a partial internal wall that extends upward from the bottom of the battery (e.g., molded) box and inward from the sides of the molded box. The slot defined by the dividers may have a tapered width such that the slot is narrower at the bottom of the molded box than it is at the top. This tapered slot will receive a tapered electrode assembly which is also narrower at its lower portion than at its upper portion. The taper is referred to as a draft angle herein. The width and draft angle of the slots defined by the internal dividers may vary to accommodate different thicknesses of electrode assemblies or different methods of sealing between distinct cells formed by the electrode assemblies.

In some aspects, the battery box is a single piece (i.e. molded) box composed of non-conductive composite resin that has an open interior for receiving the electrode assemblies and other battery components therein. The dividers, if present, are also formed from a non-conductive composite resin and may be molded with the battery box or inserted (e.g. welded) into the battery box during battery assembly. The non-conductive resin is a blended composite of one or more non-conductive polymers, which may include polypropylene, high density polyethylene, polystyrene, polyphenylene oxide, polyvinylchloride or polyphenylene ether or any other suitable thermoplastic materials that are chemically compatible with the electrolytes used in battery devices. The material may be further compounded with structural fillers (including glass fiber, glass bead, or silica fume), pigmenting materials (including carbon black or titania), or flame retardants. In some aspects, the battery box may be injection molded or machined. In some aspects, the non-conductive composite resins might be a multilayer coated article. In those aspects, the battery box substrate or base is not, required to be thermoplastic.

The battery box houses terminal electrode assemblies, i.e., an anode and a cathode, and at least one bipolar electrode assembly. In one aspect, the at least one bipolar electrode assembly has a component constructed of a conductive composite resin. Conductive composite resins are polymers such as a polyolefin or fluoropolymer that is compounded with a conductive diluent (e.g., metal, graphite, etc.). In one aspect, the polymer is preferably a homopolymer or co-polymer of polyethylene (PE). polypropylene (PP), or polyvinylidene fluoride compounded with a conductive carbon, such as carbon black, graphite, carbon fiber, or a combination thereof. The composite may also contain a structural filler, such as glass fiber, glass bead, or silica fume. The composition and methods of mixing materials to form the conductive composite resin are described in U.S. Pat. No. 4,169,816 to Hsue C. Tsien (ExxonMobil Research and Engineering Co., Applicant) and U.S. Pat. No. 5,173,362 to Tekkanat, Bora, et al. (Johnson Controls Battery Group, Inc, Assignee), both of which are incorporated by reference herein. Conductive composite resins suitable for use in the electrode assemblies for the batteries described there have an intrinsic volume resistivity that is less than about 10 ohm-cm. In one aspect the intrinsic resistivity is less than about 1 ohm-cm. As used herein, “about” conveys that there is variability in each dimension or value and that such dimension or values vary about five percent from the stated value or dimension. In aspects of the electrode assemblies described herein, conductive composite resins are used to form an electrode plate. In another aspect, the bipolar electrode comprises a metal or semiconductor (i.e., uncoated). Examples of suitable metals include, but are not limited to, titanium, aluminum or other suitable metals. Examples of suitable semiconductors include, but are not limited to, titanium carbide (TiC), silicon carbide (SiC) or other such materials.

The electrode assemblies can also include a conductive material in contact with the conductive composite resin. Suitable conductive materials include carbon that can reversibly absorb bromine species (e.g., aqueous bromine or aqueous bromide) that is substantially inert in the presence of the electrolyte.

In some aspects, the dividers are configured to have a first portion, a second portion, and a third portion. The first portion extends along a first sidewall of the battery box, the second portion extends along the bottom of the battery box. and third portions extends along the opposite wall of the battery box. As noted above, the dividers separate the slots that receive electrode assemblies from each other.

The bipolar battery molded box houses a plurality of electrode assemblies and includes two terminal electrode assemblies nearest to the longitudinal walls of the battery box, one of which is a terminal anode electrode assembly and another of which is a terminal cathode electrode assembly. The one or more electrode assemblies received by individual slots between the slots that house the terminal electrode assemblies are the one or more bipolar electrode assemblies. Each electrode assembly is received into a separate slot. In some aspects, the separation of the slots is provided by the electrode assemblies themselves. The electrode assemblies may have a perimeter support that extends around the perimeter of the electrode assemblies to form a seal, or cooperate with the dividers, slots and/or the battery box walls to form gas/liquid seals between slots. When the battery box is assembled and the slots are filled with electrolyte, the slots are battery cells.

The terminal electrode assemblies have a current collector that may be formed from the conductive composite resin, a metal or semiconductor encapsulated in the conductive composite resin or a metal or semiconductor (i.e. uncoated). Examples of suitable metals include titanium, aluminum or other suitable metals. Example of suitable semiconductors include titanium carbide (TiC), silicon carbide (SiC) or other such materials. Current collectors can have a variety of configurations. Whatever configuration is selected will allow the current collector to be received into the terminal slot in the battery box to form the terminal electrochemical cell in the battery box.

In some aspects, each bipolar electrode may contain a conductive composite polymer electrode formed from the conductive composite resins herein described (hereinafter “CPE”) sheet which is an electrode formed from the conductive plastic resin. In some aspects, the CPE sheet has a carbon material attached thereto. In one aspect. the carbon material is a carbon felt

In some aspects, the electrode assemblies describe herein may be sealed by a perimeter support. In one aspect the CPE sheet carrying the carbon material is sandwiched between two perimeter supports. In a further aspect, the perimeter support(s) may be over molded gaskets that seal the entire perimeter of the CPE sheet to provide cell-to-cell sealing. Such perimeter support(s) provide mechanical support to the electrode assemblies in addition to sealing in the contents of a slot in which the electrode assembly is disposed (i.e., the electrolyte added to slot in which the electrode assembly is disposed).

As noted above, in some aspects, the bipolar electrode assembly may be composed, of a CPE sheet joined to a piece of carbon material on one of its two faces. This may entail vacuforming or otherwise pressing together a CPE sheet and piece of carbon material at elevated temperature. However, other methods of assembly are possible, such as injection molding of the conductive resin around the carbon material.

Described herein is method for assembling a battery with housing formed from a non-conductive plastic. As such the housing can be molded or formed from other techniques such as 3D printing, welding, etc. The battery box is assembled with slots to receive electrode assemblies therein. In one aspect. the electrode assemblies are formed by assembling a CPE sheet that carries a conductive carbon material, in one aspect the carbon material formed as a carbon felt.

The electrode assemblies can be formed and placed in the battery box in a variety of different ways so that each slot is sealed from the other slots (to mitigate or prevent electrolyte from transporting among the battery cells). In one aspect, the battery box has dividers that are dimensioned to receive the perimeter support of the electrode assemblies therebetween. The perimeter supports themselves can be over molded on the perimeter of the CPE sheet, but not the carbon material (e.g. the carbon felt) carried by the CPE sheet. In one aspect the perimeter support is a frame that fits over the CPE sheet on both sides of the perimeter of the CPE sheet. In one aspect the perimeter support has an inner sealing material, over which is formed a perimeter support fashioned as a stiffening insert, over a portion of which is applied an outer sealing material. In another aspect, the dividers receive a stiffening insert. The stiffening insert forms a seal with the sealing material disposed on the perimeter of the CPE sheet. As used herein, stiffening inserts are one aspect of perimeter supports described herein.

Once the electrode assemblies are received by the battery box, electrolyte is added to cells defined by the electrode assemblies either alone or in combination with other structures in the battery box (e.g., slots, dividers, etc.) and a lid is placed on the battery box. The lid can be affixed to the battery box by any conventional method such as welding, thermoforming, adhesive, etc.

### BRIEF DESCRIPTION OF DRAWINGS

The drawings described herein are for illustrative purposes only of selected configurations and are not intended to limit the scope of the present disclosure.

FIG. 1A and FIG. 1B are perspective views of a molded battery box according to one aspect of the bipolar battery assemblies described herein.

FIG. 2 is a cross-sectional diagram of an assembled bipolar battery box according to one aspect of the description.

FIGS. 3A and 3B are, respectively, an exploded view of a battery box and one bipolar electrode assembly and a perspective view of an assembled battery box with an anode electrode assembly, a cathode electrode assembly, and a plurality of bipolar electrode assemblies placed therebetween according to one aspect of the description.

FIG. 4 is a schematic view of a bipolar electrode with a tapered profile being received by a tapered slot in the molded battery box.

FIGS. 5A and 5B illustrate an assembled electrode with a perimeter support.

FIGS. 6A-6C illustrate a bipolar electrode assembly according to another aspect of the battery box described herein.

FIGS. 7A and 7B illustrate one aspect of the terminal anode and cathode electrodes described herein.

FIG. 8 illustrates a CPE sheet and a carbon felt affixed thereto according to one aspect of the battery box described herein.

FIG. 9 is a diagram of one aspect of a metal current collecting material sheet.

FIGS. 10A-10E illustrate another aspect of the bipolar electrode assembly described herein.

FIG. 11 illustrates a cross-section of another aspect of the battery box described herein in which the battery box is assembled without stiffener sheets.

FIGS. 12A-12C illustrate another aspect of the bipolar electrode assembly described herein.

FIGS. 13A-13D illustrate another aspect of the bipolar electrode assembly described herein.

FIG. 14 is a cut-away detail view of a portion of the assembled battery box described herein having a different stiffener structure for receiving the bipolar electrode assemblies therein.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “joined to,” or “coupled to” another element or layer, it may be directly on, engaged, connected, joined, or coupled to the other element or layer, or intervening elements or layers may be present. In contrast, when an element is referred to as being “directly on,” “directly engaged to,” “directly connected to,” “directly joined to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second.” and other numerical terms do not imply a sequence or order unless clearly indicated by the context. Thus, a first element, component, region, layer or section discussed below could be termed a second element, component, region, layer or section without departing from the teachings of the example configurations.

The terms upper, lower, above, beneath, right, left, etc. may be used herein to describe the position of various elements with relation to other elements. These terms represent the position of elements in an example configuration. However, it will be apparent to one skilled in the art that the frame assembly may be rotated in space without departing from the present disclosure and thus, these terms should not be used to limit the scope of the present disclosure.

As used herein, the term “battery” encompasses electrical storage devices comprising at least one electrochemical cell.

As used herein, the term “electrochemical cell” or “cell” are used interchangeably to refer to a device capable of either generating electrical energy from chemical reactions or facilitating chemical reactions through the introduction of electrical energy.

As used herein, an “electrolyte” refers to a substance that behaves as an ionically conductive medium. For example, the electrolyte facilitates the mobilization of electrons and cations in the cell. Electrolytes include mixtures of materials such as aqueous solutions of metal halide salts (e.g., ZnBr₂, ZnCl₂, or the like).

As used herein, the term “electrode” refers to an electrical conductor used to make contact with a nonmetallic part of a circuit (e.g., a semiconductor, an electrolyte, or a vacuum). An electrode may also refer to either an anode or a cathode.

As used herein in, the term “anode” refers to the negative electrode from which electrons flow during the discharging phase in the battery. The anode is also the electrode that undergoes chemical oxidation during the discharging phase. However, in rechargeable cells, the anode is the electrode that undergoes chemical reduction during the cell's charging phase. Anodes are formed from electrically conductive or semiconductive materials, e.g., conductive plastics or composites, metals (e.g., titanium or aluminum, etc.), metal oxides, metal alloys, metal composites, semiconductors (e.g., TiC, SiC), or the like.

As used herein, the term “cathode” refers to the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., conductive plastics or composites, metals (e.g., titanium or aluminum, etc.). metal oxides, metal alloys, metal composites, semiconductors (e.g., TiC, SiC), or the like.

As used herein, the term “bipolar electrode” refers to an electrode that functions as the anode of one cell and the cathode of another cell. For example, in a battery stack, a bipolar electrode functions as an anode in one cell and functions as a cathode in an immediately adjacent cell. In some examples, a bipolar electrode comprises two surfaces, a cathode surface and an anode surface, wherein the two surfaces are connected by a conductive material. For instance, a bipolar electrode plate may have opposing surfaces wherein one surface is the anode surface, the other surface is the cathode surface, and the conductive material is the thickness of the plate between the opposing surfaces.

### I. Aspects of the BiPolar Battery Assemblies Described Herein

Described herein is a battery that deploys conductive plastic electrodes, or a combination of conductive plastic bipolar electrodes and metal terminal electrodes, in a non-conductive battery box. Electrodes made of conductive plastic materials are known. Such materials are less rigid than metal electrodes, but have smaller temperature stability windows. Therefore, conventional battery sealing approaches are challenging when conductive plastic electrodes are deployed in conventional battery structures. Described herein is a mechanical design that mitigates the challenges listed above by mechanically inserting and sealing the electrodes directly into slots within a single piece molded box, and subsequently sealing the entire box with a lid. This design allows the final battery form factor and its associated tolerances to be largely fixed during a single process step during molding or other fabrication of the box and significantly reduces the number of possible external leak pathways, resulting in greater manufacturing yields. This approach may also reduce cost and simplify manufacturing by reducing the number of total components to be manufactured for the battery casing or by relaxing requirements on material properties for components. As the design allows for a focus on sealing only around the edges of bipolar electrodes between adjacent cells, the design also allows for greater flexibility than when rigid metal electrodes, softer conductive plastic electrodes, or other bipolar electrode materials are used in battery assemblies. Collectively, these advantages allow for improved manufacturing yield, simpler manufacturing, and reduced overall cost of the battery relative to other designs that are often described.

In one aspect, described herein is a design for a static bipolar battery having at least one electrochemical cell within a molded box and a method for assembling such a battery. In one aspect, the bipolar battery is a zinc bromine battery. Rather than joining individual modular frames and electrodes together, the electrodes are inserted into a single piece molded box that is configured to receive them. The electrodes may be inserted directly into slots in the molded box, or may be encapsulated in a perimeter support (also described as a “window frame” herein) and subsequently inserted into the molded box. If the electrodes are directly inserted into slots in the box they may be sealed using a liquid gasket/adhesive or directly joined to the box. If the electrodes are first encapsulated within the plastic perimeter support a gasket/adhesive may be applied directly onto the plastic perimeter support, with a compression seal being achieved when the perimeter support with the bipolar or encapsulated electrode is received into the slots in the molded box. The slots in the molded box may have a draft angle that may serve to create this seal around the perimeter support when the perimeter support with encapsulated electrode perimeter is pressed into the slots. Draft angles are well known in thermoforming processes and are typically from about 1 to about 5 degrees to address material shrinkage during the, molding process. In certain aspects, the perimeter support may have a stiffener incorporated therewith. In other aspects the stiffener support is separated from the electrode assemblies. In other aspects, the assembled battery box does not have a stiffener included therein.

After tilling the individual cells in the battery with electrolyte, a lid may be welded (or otherwise joined) onto the top of the molded box containing the electrodes. This design creates a bipolar battery which cannot leak electrolyte out of the bottom or sides, as all electrodes are enclosed in the molded box and only the top is sealed (i.e., there are no potential leakage pathways through the bottom or sides of the battery box). Additionally, this design also provides an efficient manufacturing process compared to assembly processes that require joining frames and electrodes together to assemble the bipolar battery. The design and manufacturing method described herein are better suited for conductive plastic bipolar and terminal electrodes, which may be formed of conductive plastic or metal, Other designs and methods, that deploy joining processes to assemble bipolar batteries that are not compatible with conductive plastic electrodes.

Mechanically encapsulating the perimeter edges of the conductive plastic electrodes and then mechanically inserting them into a molded box is an efficient and effective approach to sealing and assembling a bipolar battery utilizing conductive plastic electrodes. It also allows for the use of electrodes of mixed materials, e.g. conductive plastic bipolar electrodes and metal terminal electrodes. It also allows for the use of conductive plastic electrodes materials which would otherwise be difficult to weld or co-injection mold easily, allowing for use of a wider range of conductive diluents to be added to the conductive plastic electrodes. This in turn reduces the resistance of the conductive plastic electrodes and improves the energy efficiency of the bipolar battery.

While a zinc bromine battery is described herein, such description is illustrative, not limiting. The battery design and method of manufacture described herein may be used with any static bipolar battery chemistry.

Also, although the battery box is described herein as made by molding or injection molding, the battery box may be manufactured by machining or any other suitable and conventional technique for fabricating plastic articles. Molding is a low cost method with higher manufacturing throughput.

Also, there are many alternative methods for sealing adjacent cells within the box, including compression seals, liquid/cured seals, over molded seals (over molded either onto the electrodes themselves or over molded onto the plastic window frame). The battery box and method described herein are not limited to the specific seals described herein. Also, while the battery box design is compatible with conductive plastic electrodes, metal electrodes can be used either in their entirety or as part of an assembly with plastic or conductive plastic in the designs and methods described herein.

As noted above, sealing electrodes between adjacent cells is accomplished by either compression sealing, using a draft angle in the slots in the box, pre-cured gasket sealing, or by sealing around the slot with a liquid type seal which cure in place around the electrodes that are inserted into the slots in the box.

There are multiple different sizes and shapes for the box and for the slots that receive the electrode assemblies. The number of cells that may be included in the battery box and their orientation are largely a matter of design choice. Different methods for making external electrical contact with the terminal electrodes inside the bipolar stack in the battery box are contemplated, as are different orientations of the terminal electrodes. Multiple different methods of attaching/sealing the lid to the battery box after the electrodes have been inserted and filled with electrolyte are also contemplated. Multiple different methods of creating a vent or pressure relief valve in the lid on the box are contemplated. Multiple different features may be added to the lid to prevent, electrolyte from spilling or sloshing from one cell to the next during shipping, handling, operation, etc., are contemplated. Multiple methods of assembling the conductive plastic bipolar and terminal electrodes prior to inserting them into the battery box (or encapsulating them within plastic window frame) are contemplated. Multiple methods of attaching the carbon material to the conductive plastic electrodes prior to inserting the electrodes into the box are contemplated. Multiple methods of roughening the surface of the conductive plastic electrodes to make them suitable for metal plating (e.g., zinc plating) prior to inserting into the box are contemplated. However, the battery box is now described in illustrative aspects.

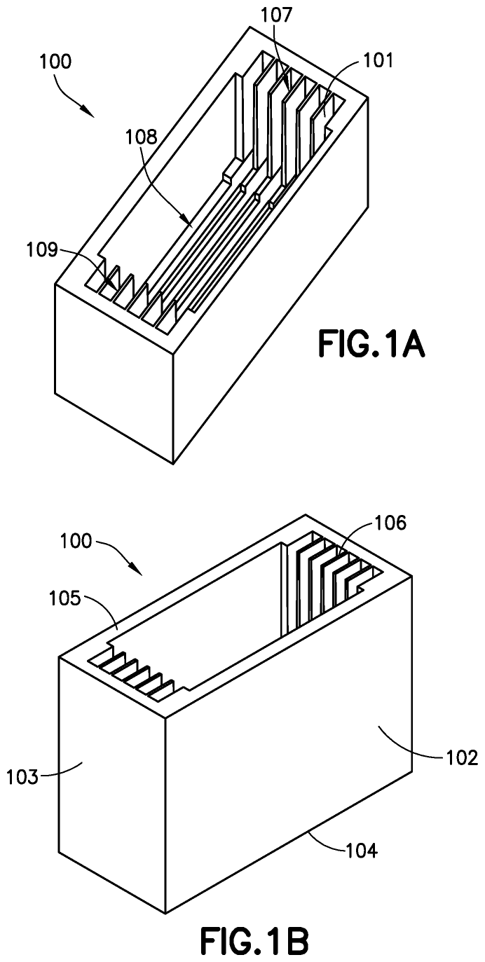

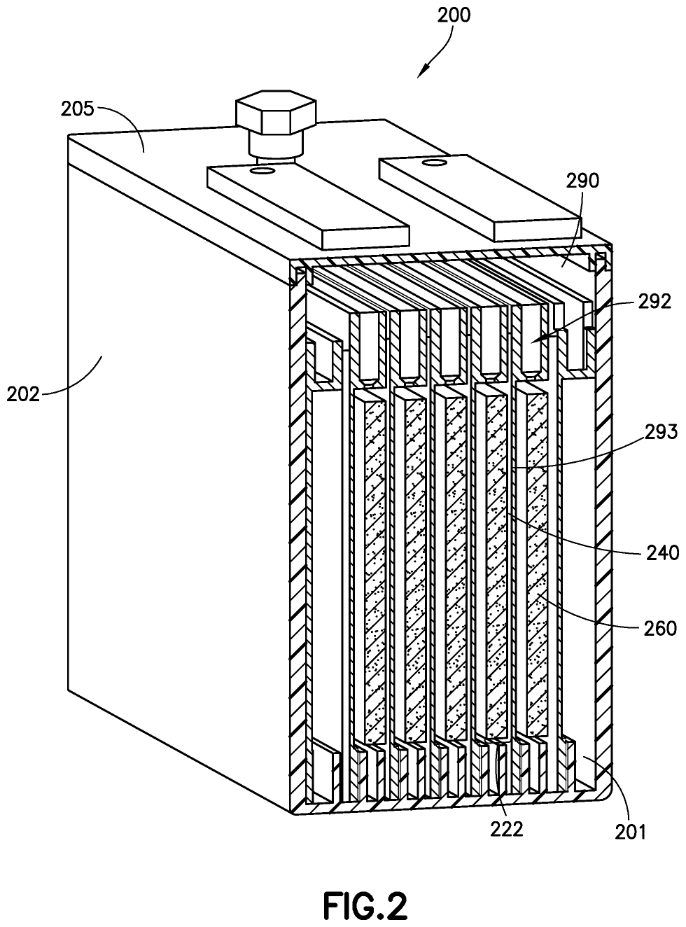

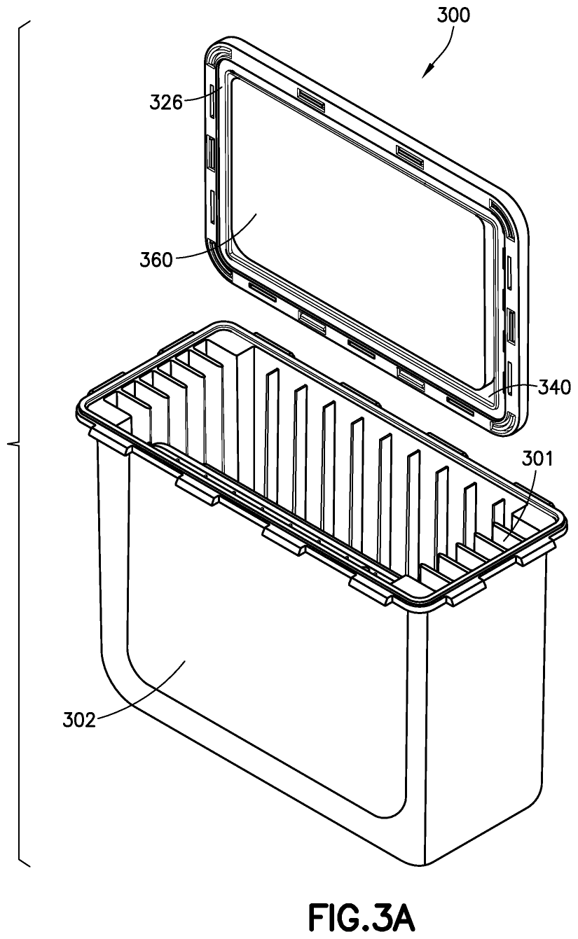

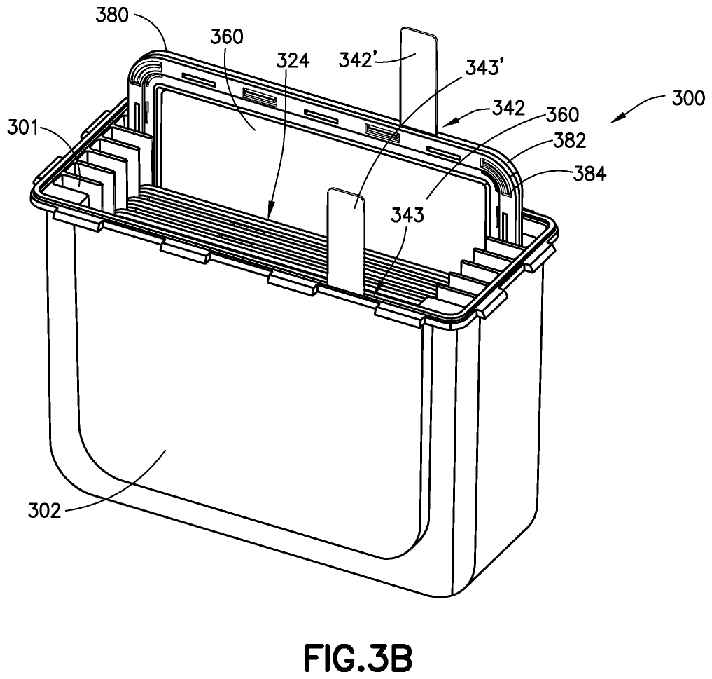

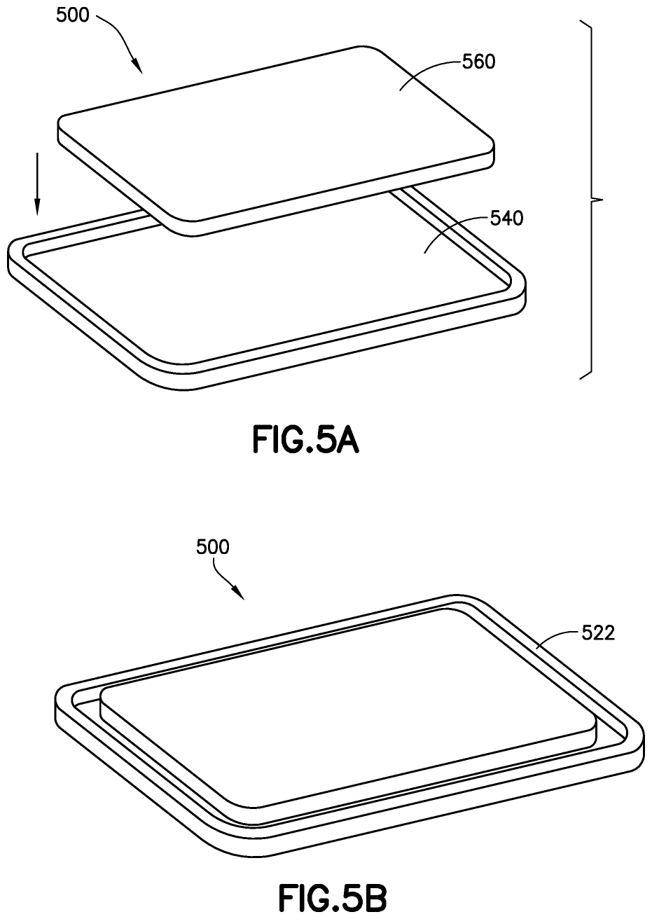

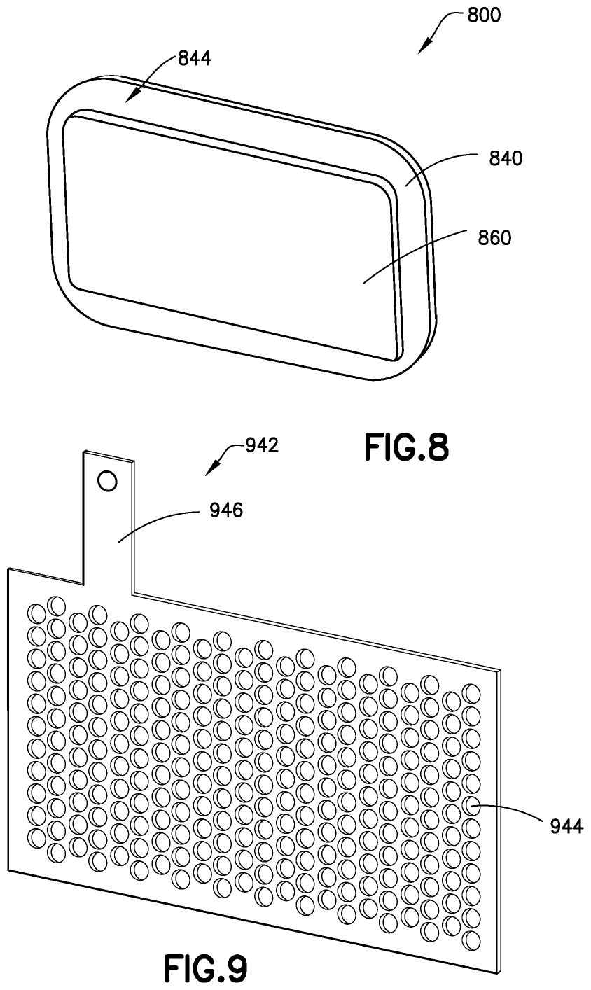

As illustrated below, the battery box is illustrated in FIG. 1. FIG. 2 is a cross section of an assembled battery with bipolar electrodes placed in the intermediate slots and terminal electrodes received in the end slots. FIGS. 3A and 8 illustrate the conductive plastic bipolar electrode with felt attached. FIG. 3B illustrates battery box with conductive plastic bipolar electrodes and conductive plastic terminal electrodes with terminal tabs to provide for external electrical connection. External electrical connectors/connections may be in the form of tabs, studs, threaded hardware, soldered hardware, etc. One of skill in the art is aware of the many types of external electrical connectors/connections that might be used herein. As such, external electrical connectors/connections are not described in detail herein. FIGS. 5A and 5B illustrate how the bipolar electrodes are assembled according to one aspect of the bipolar battery described herein.

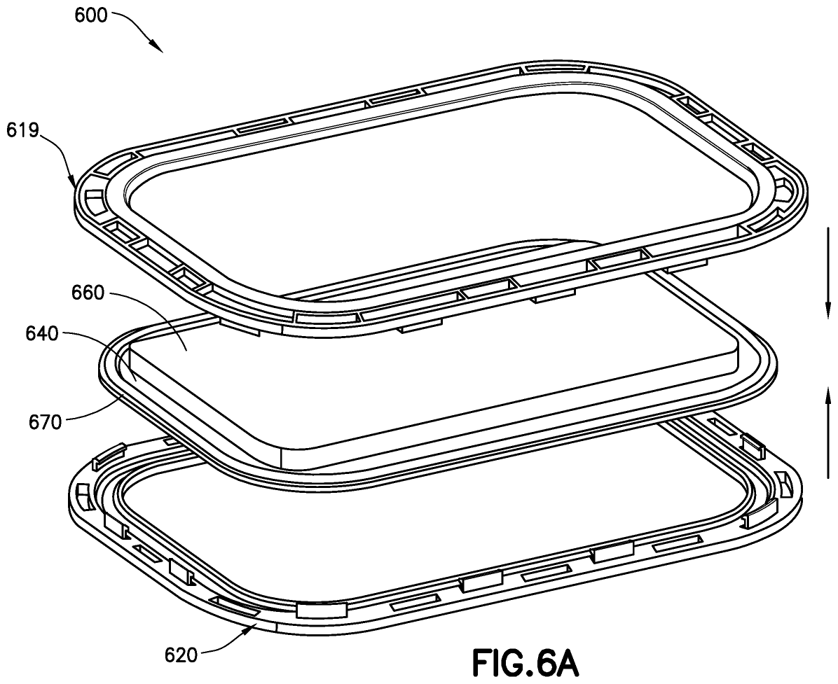

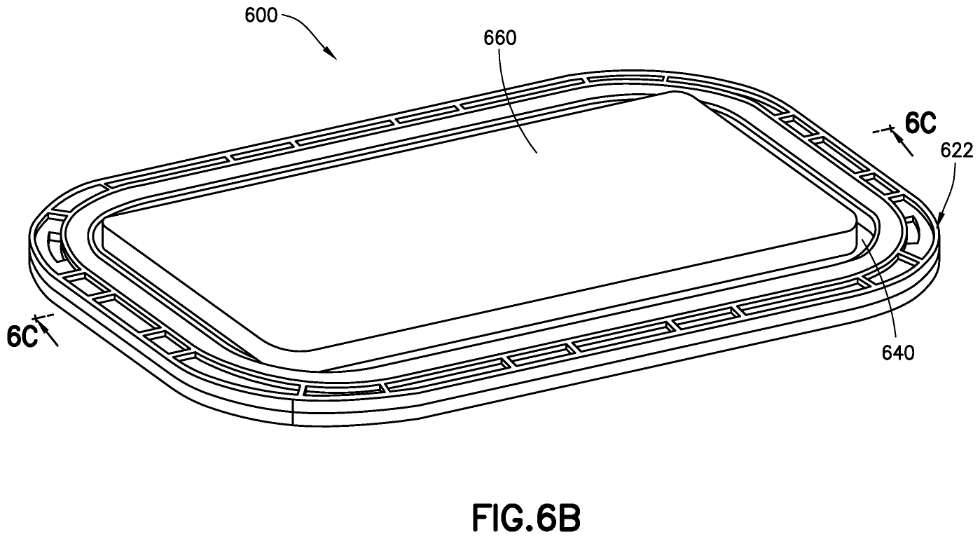

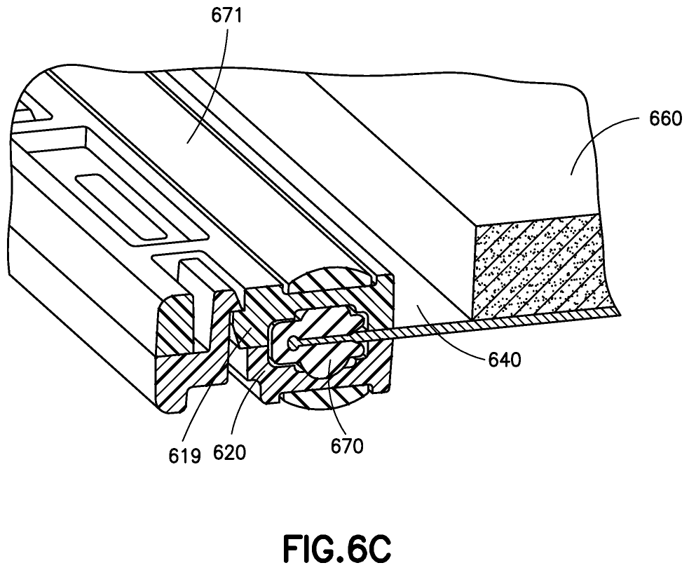

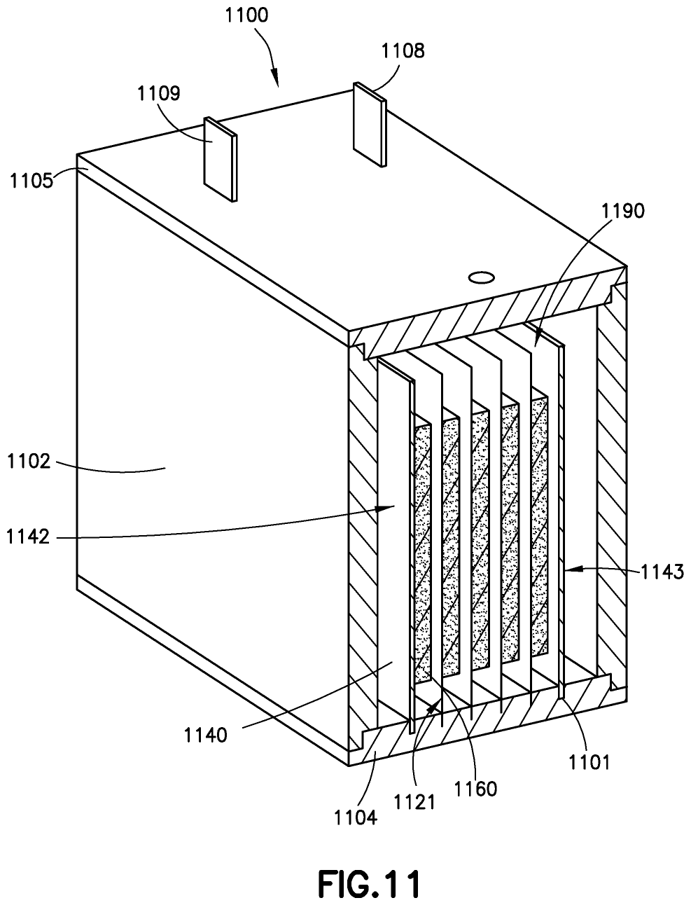

After assembly, the electrode assemblies are sealed and placed in the battery box (in slots defined by dividers) as illustrated in FIGS. 2, 3B and 11 (the battery box in FIG. 11 does not include stiffener plates). FIG. 5A, 5B, 6A-6C, 10A-10E, 12A-12C, and 13A-13D illustrate the electrode assembly being formed by enclosing the perimeter of the CPE in a perimeter support. FIG. 6 illustrates a stiffener perimeter support. FIG. 3A illustrates the electrode assembly (with plastic perimeter support) being inserted into the molded battery box. FIGS. 2 and 11 also illustrate the battery box lid, with an illustration of one aspect of the lid assembly that receives conductive tabs for external electrical connection, pressure regulation safety valves, and anti-slosh (for any electrolyte not contained by the electrodes).

### II. Battery Box

Referring to FIGS. 1A and 1B, a molded battery box 100 containing a plurality of slots 101 extending longitudinally along the length of the molded box 100 enclosed within a plurality of longitudinal walls 102 is illustrated. Length, as used herein, is the direction across an individual cell, while width is in the direction of cell stack. The molded battery box also has a plurality of lateral (e.g., sidewalls) walls 103, a bottom wall 104, and a top portion 105. Each slot 101 is at least partially separated by its neighboring slot by dividers 106. Each divider 106 extends in length longitudinally along the length of the molded box 100, and the width and draft angle of the dividers 106 may vary to accommodate different thicknesses of electrode assemblies or different methods of sealing between distinct cells formed by the electrode assemblies.

In some embodiments, a divider has a first portion 107 (that extends along the interior of a first sidewall 103), a second portion 108 (that extends along the bottom wall 104), and a third portion 109 the extends along the interior of a second, opposing sidewall 103. The first 107 and third portions 109 may have a same or similar height, and the second portion 108 may be shorter.

Referring to FIG. 2, a cross-sectional diagram of a bipolar battery molded box 200 housing a plurality of electrode assemblies 222 and containing a plurality of slots 201, wherein the two electrodes which are nearest to the longitudinal walls 202 are, respectively, a terminal anode electrode (not shown) and a terminal cathode electrode (not shown), and the other electrode assemblies 222 are bipolar electrodes disposed in the intermediate divided portions. The battery box is a non-conductive box-like structure composed of non-conductive composite resin. For example, the non-conductive resin may be a blended composite of one or more non-conductive polymers, which may include polypropylene, high density polyethylene, polystyrene, polyphenylene oxide, or polyphenylene ether. The material may be further compounded with structural fillers (including glass fiber, glass bead, or silica fume), pigmenting materials (including carbon black or titania), or flame retardants. In some embodiments, the battery box may be formed by injection molding or may be machined, 3D printed, or formed by other conventional methods for forming such structures.

In some aspects, the top cover 205 is initially absent to allow for insertion of the electrode assemblies 222 into the slots and to allow for electrolyte to be added to the slots thereby forming the battery cells. The lid may be a solid piece of non-conductive resin of appropriate size to close the battery casing. The lid may have machined holes to accommodate external terminals and/or pressure regulation hardware. The lid may be sealed to the battery casing and external terminals after assembly by a sealing material (e.g., a compression seal, an elastomer, a glue, etc.) or infrared, vibration, laser, or other known method of plastic welding. Sealing materials for the battery box are well known and not described in detail herein. Suitable sealing materials provide a liquid/gas tight seal so that electrolyte and head space gases do not escape from the sealed battery box. The battery lid may contain additional features to facilitate filling of cells with electrolyte or to mitigate transport of liquid between cells within the battery.

With reference to FIG. 2, the battery box 200 contains a gas channel 290 in the top cover 205 and filling ports 292 for introducing electrolyte into the slots bound by the electrode assemblies 222 to form the battery cells.

In the battery box illustrated in FIG. 2, the intermediate electrode assemblies are bipolar electrodes and the end assemblies are a terminal anode electrode on one end and a terminal cathode electrode on the other end. The bipolar battery molded box 200 may have a plurality of slots 201. Each bipolar electrode may contain a CPE sheet 240 with a carbon material (felt 260) attached. Also provided is a stiffening insert 293 or assembly that is disposed on the perimeter of the CPE sheet to provide the CPE sheet with mechanical rigidity at its perimeter.

In other aspects, the carbon material affixed to the CPE sheet may be carbon black and may be formed from or also include other furnace-processed carbons. Suitable carbon black materials include, but are not limited to, Cabot Vulcan® XC72R, Akzo-Nobel Ketjenblack EC600JD, and other matte black mixtures of conductive furnace process carbon blacks. In some embodiments, the carbon material may also include other components, including but not limited to a polytetrafluoroethylene (PTFE) binder and de-ionized water. For example, the carbon material has a water content of less than 50 wt % (e.g., from about 0.01 wt % to about 30 wt %) by weight of the carbon material. In some embodiments. the carbon material comprises PTFE (e.g., from about 0.5 wt % to about 5 wt % by weight of the carbon material).

Referring to FIGS. 3A and 3B, illustrated are perspective views of a bipolar battery molded box 300 containing a plurality of slots 301, in two different stages of assembly. FIG. 3A, illustrates the molded battery box wherein a bipolar electrode assembly 324 is illustrated in an exploded view above one of the slots 301. FIG. 3B illustrates the molded battery box 300 with each slot occupied by an electrode assembly, The two electrode assemblies which are nearest to the longitudinal walls 302 comprise a terminal anode electrode 343 and a terminal cathode electrode 342, and the other electrodes 324 are bipolar electrodes. The terminal anode electrode 343 may comprise a current collecting material sheet (e.g. a metal as described elsewhere herein) that may be combined with one or more CPE sheets 340 (or wherein the metal sheet may be embedded in a conductive plastic resin). As illustrated, a portion of the current collecting material sheet 342′, 343′ is exposed to allow for external electrical connection. The terminal cathode electrode 342 is further distinguished from the terminal anode electrode 343 by attachment of a carbon material felt 360 to one of its two faces, in a manner similar to that used for the bipolar electrodes 324. Each electrode maybe sealed within an optional perimeter support 380 comprising, in one aspect, two stiffener plates 382. 384 for each CPE sheet, and may be enclosed by over molded gaskets 326 on all four sides to provide electrode cell-to-electrode cell sealing.

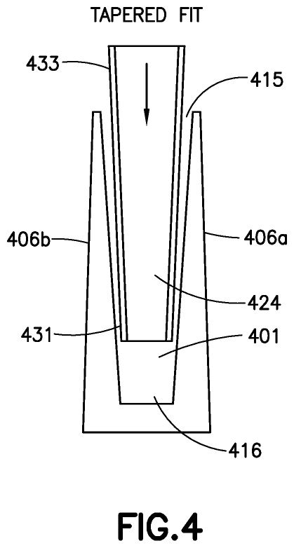

As noted above, it is important for the electrode assemblies to fit snugly into the battery box as the snug fit improves the seal provided by any perimeter support and lends further mechanical support to the electrode assemblies. FIG. 4 illustrates a slot, 401 with dividers 406a and 406b, each of which has a tapered profile so that the top 415 of the slot 401 is wider than the bottom 416 of the slot. This tapered slot 401 will receive a tapered electrode assembly 424 which is also narrower at its lower portion 431 than at its upper portion 433. The cooperating tapers allow the slots 401 to receive the electrode assemblies in a matter that will further secure the seal formed by any perimeter support of the electrode assembly.

FIGS. 5A and 5B illustrate a basic electrode assembly 500 having a CPE sheet 540 and a perimeter support 522. A sheet of carbon material 560 is placed on one of the two faces of the CPE sheet 540. As can be seen, the carbon material fits within the perimeter defined by the perimeter support 522. The perimeter support can be applied onto the CPE sheet using conventional techniques such as over molding or injection molding. Typically, the sheet of carbon material 560 will be affixed to the CPE sheet prior to or after forming the perimeter support 522 on the perimeter of the CPE sheet 540. The sheet of carbon material can be affixed to the CPE sheet using vacuforming or other known processes for pressing together a CPE sheet and piece of carbon material at elevated temperature. Other methods of assembly are contemplated, such as injection molding of the conductive resin around the carbon material.

Referring to FIGS. 6A to 6C, in this illustrated aspect a perimeter support 622 is provided as a stiffening assembly. FIG. 6A is an exploded view of the electrode assembly 600 having a perimeter support 622. FIG. 6B is a perspective view of the electrode assembly 600 with perimeter support thereon and FIG. 6C is a detailed cross section of the perimeter support in FIG. 6B. In this example, the stiffening assembly is assembled from two pieces 619, 620 on opposite faces of the electrode assembly 600 (which has a CPE sheet 640 and a carbon material sheet 660 affixed thereto). Around the perimeter of the CPE sheet is a sealing material 670. The sealing material may be an elastomeric material over molded or cured in place on the perimeter of the CPE sheet. The two pieces of the stiffening assembly 619, 620 are configured to snap together, although this is not a requirement. After the stiffening assembly is in place, another seal 671 may be disposed over the stiffening assembly 622 such that a seal may be effected between the stiffening assembly 622 and the electrode, and between the stiffening assembly and the battery casing (not shown). The sealing materials may seal by compression, but compressionless seals are contemplated. The inner and outer sealing material may be incorporated in a number of different ways, including but not limited to an already formed gasket material which is mechanically fixed or adhered to the electrode CPE sheet and/or stiffening assembly. One example is a u-channel type gasket around the edge of the electrode assembly or a flat or rounded gasket on the outer face of the stiffening assemblies. As noted above, the seal may be an elastomeric material that is over molded or dispensed and cured in place on either the stiffening insert or the CPE sheet.

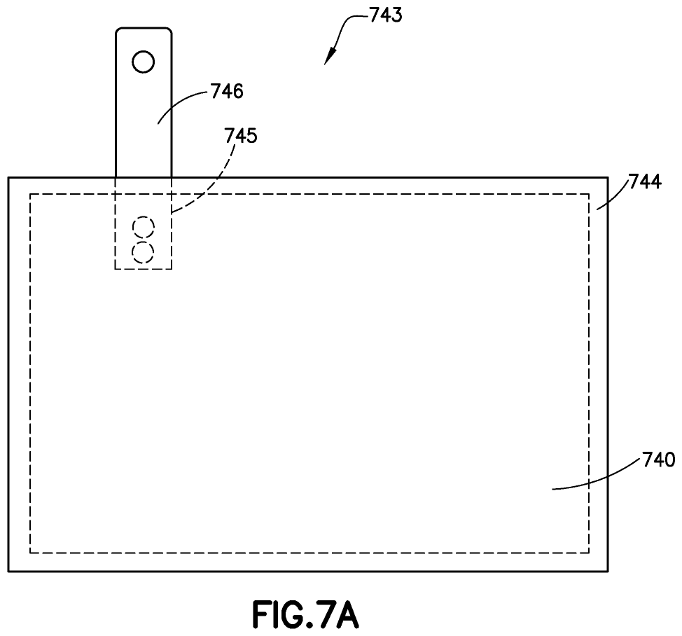

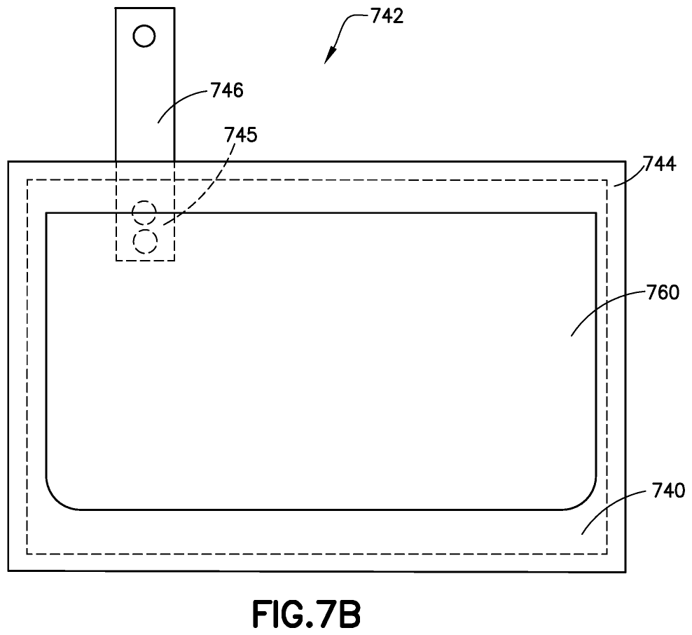

Referring to FIG. 7A, a diagram of one aspect of a terminal electrode is described. The terminal electrode may be made of a metal (e.g. titanium or aluminum), a conductive plastic, or a semiconductor such as titanium carbide or silicon carbide. The terminal electrode can also be a composite of these materials. In the illustrated aspect, a terminal anode electrode 743 assembly is formed via encapsulation of a current collecting material 745 which, as illustrated, is embedded in one or more CPE sheets 740, with a portion of the current collecting material 746 exposed to allow for external electrical connection. As stated previously, external electrical connectors/connections may be in the form of tabs, studs, threaded hardware, soldered hardware, etc. This may be accomplished via compression molding, injection molding, or a similar technique. The current collecting material can be a tab that extends into the terminal electrode, or it can be a larger surface such as the current collector illustrated in FIG. 9. The perimeter 744 may be a non-conductive seal 744.

As noted above, the battery assemblies described herein have an anode 743 and a cathode 742. The anode and cathode differ in their construction in that the cathode has a carbon material 760 (e.g. a carbon felt) attached to the conductive plastic electrode (CPE) 740. FIG. 7B illustrates such a structure. Attachment of the carbon material to the electrode 740 is discussed elsewhere herein. The current collector materials for the electrode contemplated in FIG. 7B are the same as those for the electrode assembly described in FIG. 7A.

Referring to FIG. 8, illustrated is an electrode assembly 800 without a perimeter support. The electrode assembly, as illustrated, is a CPE sheet 840 that may have a carbon felt 860 disposed thereon and attached thereto. The CPE sheet 840 has protruded perimeter 844. The carbon felt 860 is configured on the CPE sheet 840 in a way that allows for the formation of a perimeter support on the protruded perimeter that will not impinge on the area occupied by the carbon felt 860. As illustrated, in some aspects the CPE sheet 840 has rounded corners. In some aspects, the carbon felt 860 may have same or similar rounded corners to that of the CPE sheet.

In some embodiments, CPE sheet 840 may be created by further processing compounded pellet by thermally processing the resin into standalone sheet with thicknesses ranging from 0.02 to 0.1 inches, via extrusion, injection molding, or similar polymer processing method. The porosity of the material after processing into sheet may be in the range of about 0 to about 40%, but is preferred to be less than 10%.

FIG. 9 illustrates one example of a current collecting material sheet. The current collecting material provides current distribution over long length scales on a terminal electrode as well as external connection of the terminal electrode assembly to outside of the battery. The material is a metallic sheet, and may be made from copper, aluminum, titanium, stainless steel, nickel, an alloy, or other conductive metallic material. The sheet 942 may be perforated with holes or expanded to form a hole pattern 944. The perforations allow polymer to enter the holes when the current collecting material is embedded in a conductive plastic material. A tab-like protrusion 946 may be used to form an electrical connection to outside the battery. The tab-like protrusion may be welded to the current collecting material or formed from the current collecting material as a single piece.

Current collectors for use in the battery box described herein can be coated or uncoated and made of metal or conductive plastic. In one aspect the current collector is fabricated from a CPE sheet. In another aspect, the current collector is a coated metal current collector, with a pattern of openings therein that allow the coating to flow through the current collector and more securely embed the current collector in the plastic. In another aspect the current collector may be an unpatterned metal sheet.

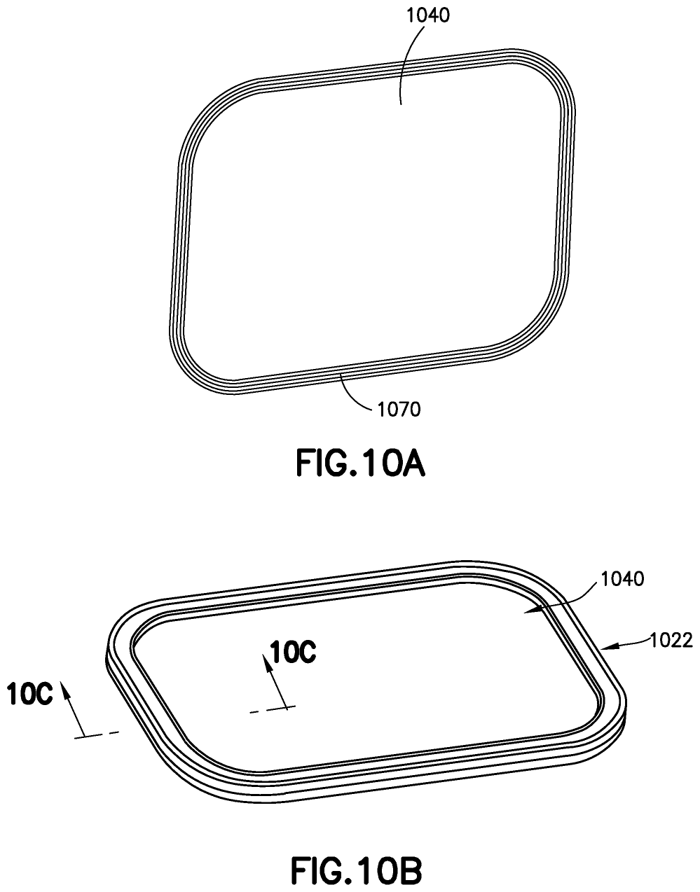

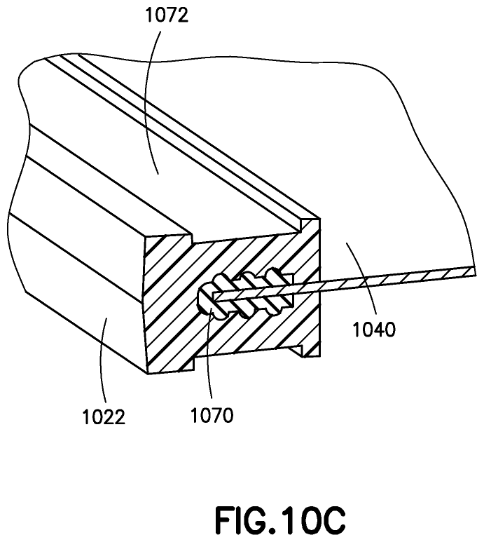

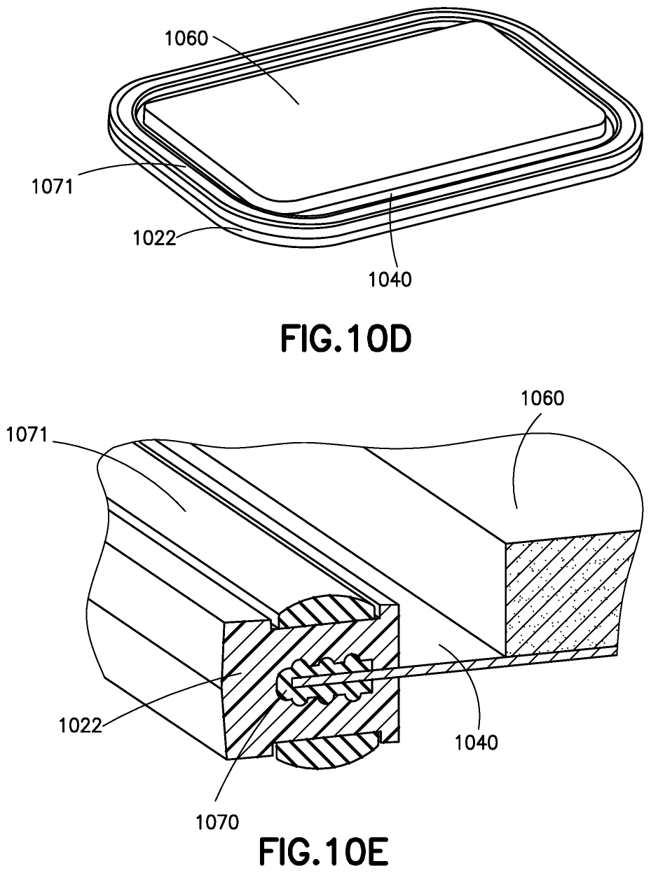

FIGS. 10A-10E illustrate an electrode and stiffener assembly that is an alternative to the assembly described in FIGS. 6A-6C. The perimeter support (stiffener assembly 1022) is formed by injection molding over a seal 1070 placed around the perimeter of the CPE sheet 1040. The carbon material 1060 (e.g. carbon felt) may be affixed to the CPE sheet 1040 either before or after the stiffener assembly 1022 is formed around the perimeter of the CPE sheet 1040. Note that the seal 1070 is placed on both sides of the CPE sheet. As is illustrated in FIGS. 6A-6C, a second seal 1071 is placed on the over molded stiffener assembly 1022. The over molded stiffener assembly may have a groove 1072 into which the second seal 1071 is received.

FIG. 11 is a cutaway view of an assembled bipolar battery that illustrates an alternative aspect of the battery box 1100 described herein. In this aspect, the battery box 1100 receives bipolar electrode assemblies 1121 without stiffener assemblies. Similarly to what is illustrated in FIG. 2, the battery box 1100 has side walls 1102, lid 1105, and headspace 1190. Electrode terminals 1108 and 1109 extend from the anode 1143 and cathode 1142 assemblies in the interior of the battery box to above the lid 1105. The bipolar electrode assemblies have a CPE sheet 1140 to which a carbon material 1160 (e.g., carbon felt) is attached, as does the cathode 1142. The slots 1101 are configured to receive the CPE sheet 1140 and are formed in the bottom 1104 of the battery box 1100. The seals between individual cells that contain a bipolar electrode may be achieved by placing a sealing material between the end of the electrode assemblies and the interior sidewall (not shown). In this aspect, the CPE sheet in combination with the sealing materials serve as battery cell dividers.

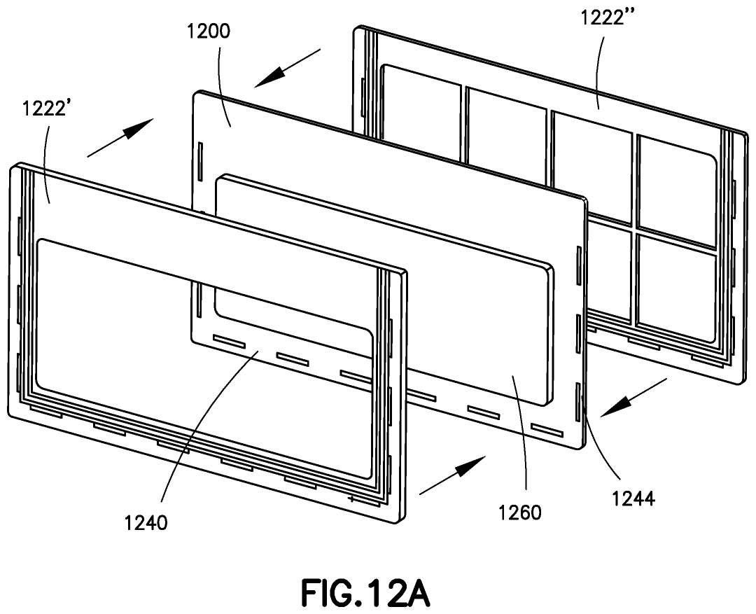

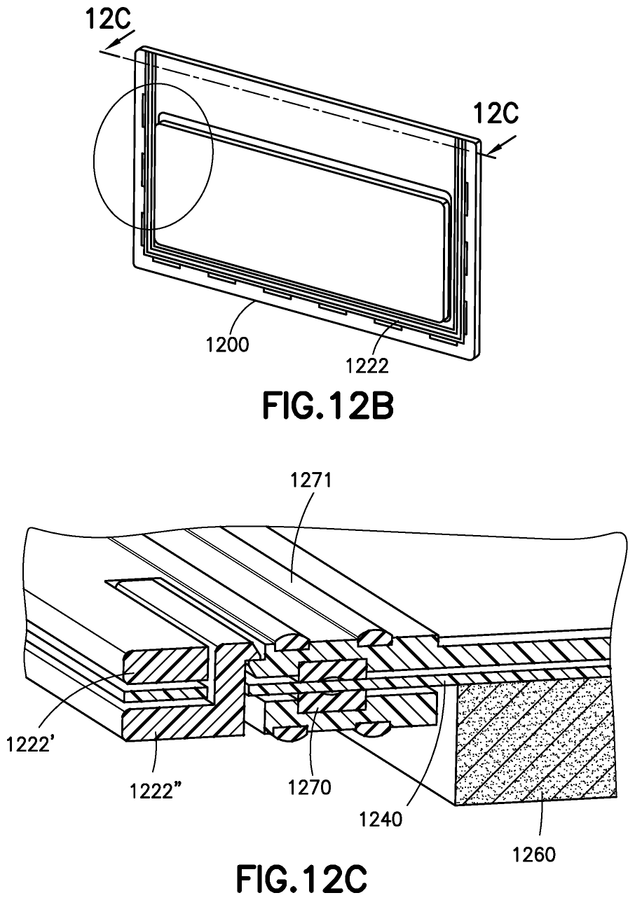

FIGS. 12A-12C illustrate another aspect of an electrode assembly for use in the batter box described herein. In this aspect, the electrode assembly 1200 is assembled with an injection molded stiffening insert 1222. The stiffening inserts may be made of a non-conductive resin or a conductive composite resin. The stiffening assemblies promote flatness of the electrode assembly and/or effect compression upon a sealing material.

As illustrated, two stiffening inserts 1222′ and 1222″ are provided. However, using only one stiffening insert is contemplated. With reference to FIG. 12A, stiffening inserts are snapped together to form the perimeter support for the electrode assembly 1200, which includes a CPE sheet 1240 and a layer of carbon material (e.g., carbon felt) 1260 affixed to the CPE sheet. The electrode assembly 1200 with the stiffening insert around a portion of its perimeter 1244 is illustrated in FIG. 12B. FIG. 12C is a detailed cut-away view of the stiffening insert with seals 1270 and 1271 formed with the stiffening insert 1222. The sealing materials may be a mechanically placed elastomer, over-molded elastomer, or cured-in-place adhesive. The seal material may be a solid type material or a foam type material. Such seals may be used to effect a liquid or gas tight seal between the electrode assembly and stiffener assembly and/or between the stiffening insert and battery casing. The stiffening insert(s) 1222′, 1222″ can be received in the slots (101, FIG. 1) of the battery box and the entire electrode assembly (i.e. the electrode with the perimeter support formed thereon and any associated seals) form a single subassembly which may be inserted into the slots in the battery box during battery assembly. With reference to FIG. 4 the electrode assembly and the slots in the battery box may both be tapered, thereby facilitating assembly of the battery.

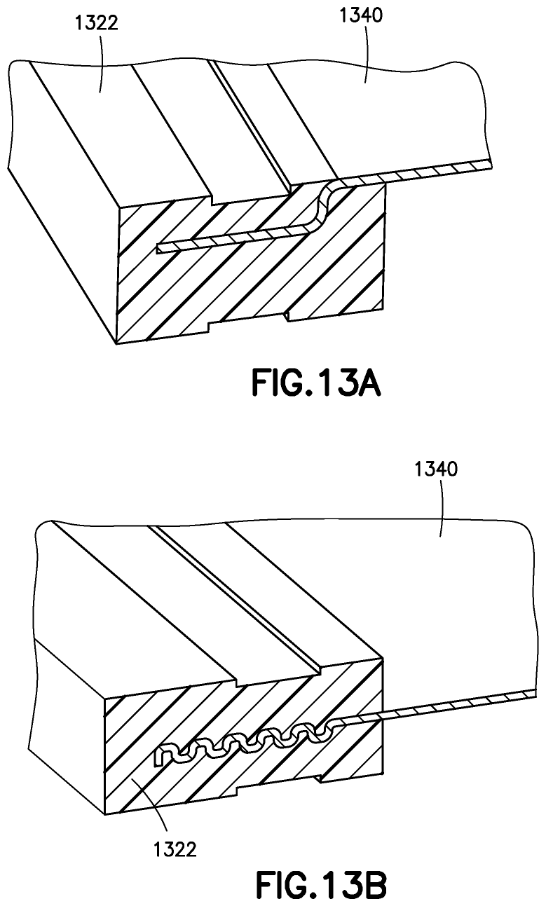

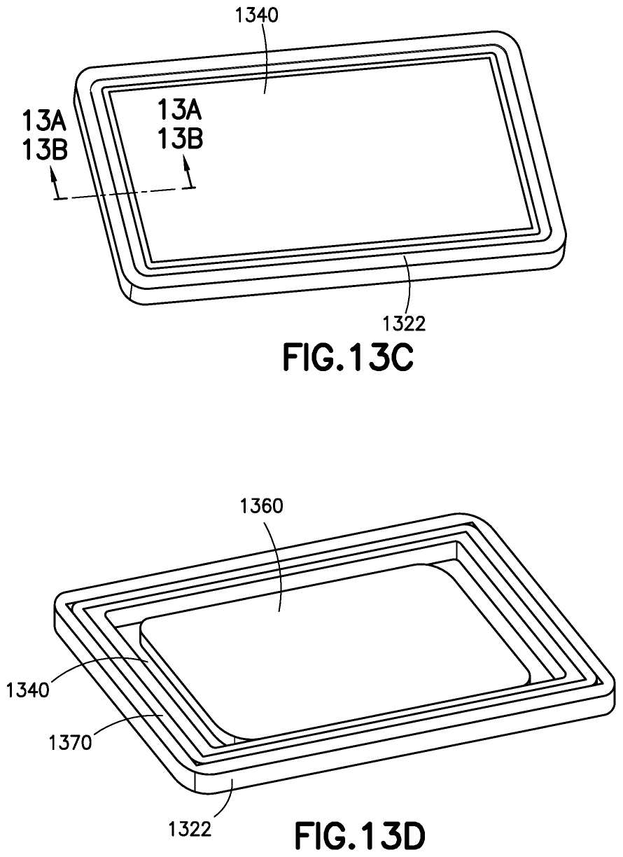

FIG. 13A-13D illustrate an electrode assembly in which the stiffening sheet and the CPE sheet are co-injection molded together. As in other assembly methods described herein, the carbon material (e.g. the carbon felt) 1360 may be affixed to the CPE sheet either before or after the electrode is completely assembled. Because the stiffening assemblies 1322 are co-injection molded with the CPE sheet 1340, separate seals are not required to be included with the stiffening assembly. As illustrated in FIGS. 13A and 13B, the stiffening assemblies can be molded in such a way as to more securely hold the portion of the CPE sheet 1340 encapsulated by the stiffening supports. After the stiffening support 1222 has been co-injection molded with the CPE sheet, a sealing material 1370 may be applied to the assembly, as illustrated in FIG. 13D As an alternative, the entire assembly (i.e. the electrode and the stiffening assembly) maybe, formed as one unitary structure by injection molding using a conductive composite resin. Again, the molding can be performed either before or after the carbon material is affixed to the conductive composite resin material. After assembly, the entire electrode assembly is received into slots in the battery box, with the perimeter being held snugly between slot dividers.

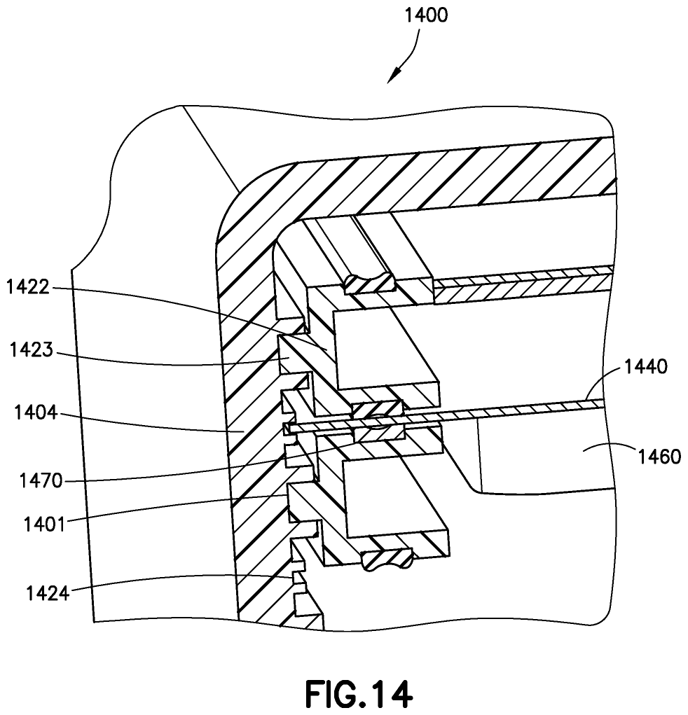

FIG. 14 illustrates another type of stiffener that can be used. FIG. 14 is a partial cutaway view of the battery box with bipolar electrode assemblies received in slots formed in the battery box 1400. FIG. 14 is oriented such that the stiffeners 1222 are received in slots 1401 formed in a side 1404 of the battery box 1400. However, what is illustrated in FIG. 14 can be oriented such that 1404 is the bottom of the battery box. The “C” shaped stiffeners 1222 illustrated in FIG. 14 are formed as a single piece and have a tongue portion 1423 that fits in slot 1401 formed in the bottom 1404 of the battery box 1400. Sealing material 1470 is applied on the outer face of the stiffening inserts 1422 to form a seal between adjacent electrode assemblies (i.e., the battery cells are sealed from each other). However, no seal is formed between the stiffening insert 1422 and the battery box 1400. As noted in FIG. 14, the electrode assembly (Le., CPE sheet 1440 to which carbon material 1460 is affixed) is held securely and separated from adjacent electrode assemblies by the stiffening inserts 1422. As illustrated, the CPE sheet 1440 is also received in a slot 1424 formed in the side or bottom 1404 of the battery box 1400.

Methods for assembling a static bipolar battery are also contemplated. According to the method, a nonconductive battery housing is provided. The battery housing is configured to receive at least one bipolar electrode assembly that is formed from conductive plastic, terminal anode assembly and a terminal cathode assembly. Optionally, the battery housing has slots that receive a single electrode assembly. The electrode assemblies, the battery box and slots cooperate to form sealed cells for each electrode assembly in the assembled static bipolar battery. Optionally, the bipolar electrodes are formed by assembling a conductive polymer electrode sheet to a carbon material. Optionally, a seal is formed on the perimeter of the conductive polymer electrode sheet. Optionally, the seal formed on the perimeter of the conductive polymer electrode sheet is formed as a stiffening insert. The carbon material can be applied to the conductive plastic sheet either before are after the seal is placed on the perimeter of the bipolar electrode assembly. After the electrode assemblies are assembled and received into the battery housing, electrolyte is added to the cells formed in the battery housing by the cooperation of the electrode assemblies, the battery housing and the slots. After the electrolyte is added to the cells in the housing, a lid is placed thereon on and sealed.

Described herein is a static bipolar battery having a housing formed of a non-conductive plastic material; a terminal cathode assembly; a terminal anode assembly; and at least one bipolar electrode assembly, the at least one bipolar electrode assembly comprising a conductive plastic resin formed into a sheet, the conductive plastic resin having a carbon material formed thereon, thereby forming a bipolar electrode. In one aspect, the housing receives the terminal cathode assembly, the terminal anode assembly and the at least one bipolar assembly such that a liquid seal is formed between adjacent electrode assemblies.

In a further aspect, the battery has a plurality of slots. In one aspect there is a first terminal slot, a second terminal slot and at least one intermediate slot, each slot receiving one of the terminal cathode assembly, the terminal anode assembly or one bipolar electrode assembly. The terminal cathode assembly may be received in one of the first terminal slot or the second terminal slot and the anode may be received in the other of the first terminal slot and the second terminal slot. In any of the above aspects, the plurality of slots are separated from each other by a divider.

The housing of the static bipolar battery described above may be formed by one of injection molding, extrusion, blow molding, or rotational molding. The conductive plastic resin of the static bipolar battery described above may be a polyolefin or a fluoropolymer. The non-conductive plastic material of the static bipolar battery described above may be a blended composite of one or more non-conductive polymers.

In one aspect, the non-conductive plastic material of the static bipolar batter may be selected from the group consisting of polypropylene, high density polyethylene, polystyrene, polyphenylene oxide, polyvinylchloride or polyphenylene ether.

In any of the above aspects, the static bipolar battery may have an electrolyte in contact with the at least one bipolar electrode assembly. In a further aspect, the electrolyte may be a zinc bromide electrolyte.

In one aspect, the conductive plastic resin of the static bipolar battery may be compounded with a carbonaceous conductive diluent. In a further aspect, the carbonaceous conductive diluent comprises metal or graphite.

The static bipolar battery in any of the above aspects wherein the polyolefin or fluoropolymer may be a homopolymer or co-polymer of polyethylene (PE), polypropylene (PP), or polyvinylidene fluoride. In a further aspect, the polymer is compounded with a conductive carbon, carbon black, graphite, carbon fiber, or a combination thereof. In a still further aspect, the polymer optionally has a structural filler, glass fiber, glass bead, or silica fume. 100871 In any of the above aspects, the carbon material of the static bipolar battery may be combined with a binder and may be a carbon black combined with a binder.

In any of the above aspects, the bipolar electrode assembly may have a perimeter support which optionally has at least one of a seal and/or a stiffening assembly. In a further aspect the stiffening assembly may be formed over the at least one seal. In a still further aspect, a second seal may be formed over the stiffening assembly.

The static bipolar battery of any of the above aspects where at least one of the anode assembly, the cathode assembly, or the anode and cathode assemblies may have the perimeter support. According to these aspects, the perimeter support may cooperate with the housing to form the liquid seal that is formed between adjacent electrode assemblies.

In any of the above aspects, the anode of the static bipolar battery may be a metal current collector. In a further aspect, the current collector is a patterned current collector. In a further aspect, the current collector may be coated with a conductive polymer.

In any of the above aspects, the anode assembly and the cathode assembly may be made of a conductive plastic resin. In a further aspect, the anode assembly and the cathode assembly may be conductive metal terminals embedded in and extending from the conductive plastic resin. In further aspect, the metal terminals may be made of titanium or aluminum.

Also described herein is a method for assembling a static. bipolar battery. According to the method, a battery housing made of a non-conductive plastic may be provided, in which the battery housing is configured to receive at least one bipolar electrode assembly that is formed from conductive plastic, a terminal anode assembly and a terminal cathode assembly. A seal is formed between cells in the battery housing, and the cells may be formed by cooperation of the electrode assemblies and the battery housing. The cells are then filled with electrolyte, after which a lid is placed on the battery housing, after which the lid is sealed. In a further aspect, the battery housing may have a plurality of slots, each slot configured to receive a perimeter portion of the electrode assembly therein. According to any of the above aspects of the method, the battery box, the plurality of slots and the electrode assemblies may cooperate to form a plurality of cells that have a liquid seal therebetween. In a further aspect, a carbon material may be affixed to the conductive polymer electrode. In yet a further aspect, a seal is formed on the perimeter of the conductive polymer electrode by applying a sealing material to the perimeter of the conductive polymer electrode. In a further aspect. the sealing material may be applied on the perimeter of the conductive polymer electrode either before or after the carbon material is affixed to the conductive polymer electrode sheet.

In any of the above aspects of the method, a stiffener may be formed with the seal on the perimeter of the conductive polymer electrode sheet.

37. The static bipolar battery of one of claims 18 and 21 wherein the seal material is a solid type or a foam type.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A static bipolar battery comprising:
a housing formed of a non-conductive plastic material;
a terminal cathode assembly;
a terminal anode assembly; and
at least one bipolar electrode assembly, the at least one bipolar electrode assembly comprising a conductive plastic resin formed into a sheet, the conductive plastic resin having a carbon material formed thereon, thereby forming a bipolar electrode; and
wherein the housing receives the terminal cathode assembly, the terminal anode assembly and the at least one bipolar assembly such that a liquid seal is formed between adjacent electrode assemblies.

2. The static bipolar battery of claim 1, further comprising a plurality of slots, comprising a first terminal slot, a second terminal slot and at least one intermediate slot, each slot receiving one of the terminal cathode assembly, the terminal anode assembly or one bipolar electrode assembly, wherein the terminal cathode assembly is received in one of the first terminal slot or the second terminal slot and the anode is received in the other of the first terminal slot and the second terminal slot.

3. The static bipolar battery of claim 2, wherein the plurality of slots are separated from each other by a divider.

4. The static bipolar battery of claim 3, wherein the housing is formed by one of injection molding, extrusion, blow molding, or rotational molding.

5. The static bipolar battery of claim 4, wherein the conductive plastic resin comprises a polyolefin or a fluoropolymer.

6. The static bipolar battery of claims 5, wherein the non-conductive plastic material comprises a blended composite of one or more non-conductive polymers.

7. The static bipolar battery of claim 6, wherein the non-conductive plastic material is selected from the group consisting of polypropylene, high density polyethylene, polystyrene, polyphenylene oxide, polyvinylchloride or polyphenylene ether.

8. The static bipolar battery of one of claim 7, wherein the bipolar battery comprises an electrolyte in contact with the at least one bipolar electrode assembly.

9. The static bipolar battery of claim 8, wherein the electrolyte is a zinc bromide electrolyte.

10. The static bipolar battery of claim 5, wherein conductive plastic resin is compounded with a carbonaceous conductive diluent. 1 L The static bipolar battery of claim 10, wherein the carbonaceous conductive diluent comprises metal or graphite.

12. The static bipolar battery of claim 10, wherein the polyolefin or fluoropolymer comprises a homopolymer or co-polymer of polyethylene (PE), polypropylene (PP), or polyvinylidene fluoride.

13. The static bipolar battery of claim 12, wherein the polymer is compounded with a conductive carbon, carbon black, graphite, carbon fiber, or a combination thereof.

14. The static bipolar battery of claim 13, wherein the polymer further comprises a structural filler, glass fiber, glass bead, or silica fume.

15. The static bipolar battery of claim 1, wherein the carbon material is a carbon black combined with a binder.

16. The static bipolar battery of claim 15, wherein the carbon material is combined with a binder.

17. The static bipolar battery of claim 1, wherein the bipolar electrode assembly further comprises a perimeter support.

18. The static bipolar batter of claim 17, wherein the perimeter support comprises at least one seal.

19. The static bipolar battery of claim 18, wherein the perimeter support further comprises a stiffening assembly.

20. The static bipolar battery of claim 19, wherein the stiffening assembly is formed over the at least one seal.

21. The static bipolar battery of claim 20, wherein a second seal is formed over the stiffening assembly.

22. The static bipolar battery of claim 21, wherein the anode assembly, the cathode assembly, or the anode and cathode assemblies further comprise the perimeter support.

23. The static bipolar battery of claim 22, wherein the perimeter support cooperates with the housing to form the liquid seal is formed between adjacent electrode assemblies.

24. The static bipolar battery of claim 1 wherein the anode assembly is a metal current collector.

25. The static bipolar battery of claim 24, wherein the current collector is a patterned current collector.

26. The static bipolar battery of claim 25, wherein the current collector is coated with a conductive polymer.

27. The static bipolar battery of claim 1, wherein the anode assembly and the cathode assembly comprise a conductive plastic resin.

28. The static bipolar battery of claim 27, wherein the anode assembly and the cathode assembly comprise conductive metal terminals embedded in and extending from the conductive plastic resin.

29. The static bipolar battery of claim 28, wherein the metal terminals are selected from the group consisting of titanium and aluminum.

30. The static bipolar battery of claim 21, wherein the seal material is a solid type or a foam type.

31. A method for assembling a static, bipolar battery comprising:
providing a battery housing made of a non-conductive plastic wherein the battery housing is configured to receive at least one bipolar electrode assembly that is formed from conductive plastic, a terminal anode assembly and a terminal cathode assembly;
forming a seal between cells in the battery housing, the cells formed by cooperation of the electrode assemblies and the battery housing;
filling the cells with electrolyte;
placing a lid on the battery housing; and
sealing the lid.

32. The method of claim 31, wherein the battery housing comprises a plurality of slots, each slot configured to receive a perimeter portion of the electrode assembly therein.

33. The method of claim 32, wherein the battery box, the plurality of slots and the electrode assemblies cooperate to form a plurality of cells that have a liquid seal therebetween.

34. The method of claim 31, wherein a carbon material is affixed to the conductive polymer electrode.

35. The method of claim 31, wherein a seal is formed on the perimeter of the conductive polymer electrode by applying a sealing material to the perimeter of the conductive polymer electrode.

36. The method of claim 35, wherein the sealing material is applied on the perimeter of the conductive polymer electrode either before or after the carbon material is affixed to the conductive polymer electrode sheet.

37. The method of claim 36, wherein a stiffener is formed with the seal on the perimeter of the conductive polymer electrode sheet.
